(19) United States
(12) Patent Application Publication
(10) Pub. No.: US 2020/0045934 A1
(43) Pub. Date: Feb. 13, 2020

(54) DURABLE DOG TOY

(71) Applicant: Worldwise, Inc., Novato, CA (US)

(72) Inventors: John James Stone, Golden, CO (US); Amy Stone, Golden, CO (US)

(21) Appl. No.: 16/535,053

(22) Filed: Aug. 7, 2019

Related U.S. Application Data
(60) Provisional application No. 62/715,336, filed on Aug. 7, 2018.

(51) Int. Cl. A01K 15/02; D07B 1/16; B29C 70/70; G10K 5/00

(52) U.S. Cl. CPC A01K 15/026; D07B 1/162; B29K 2021/003; G10K 5/00; D10B 2507/00; B29C 70/70

(57) ABSTRACT

A method of manufacturing a dog toy, the dog toy including a rope, at least a segment of which is non-linear and a thermoplastic rubber coating surrounding some but not all of the rope. The dog toy is characterized as having exposed rope and rope covered by the thermoplastic rubber along its length such that a dog using the dog toy has access to the rope for chewing but the rope is resistant to degradation due to the thermoplastic rubber coating. The method includes bending the rope for a sufficient period of time such that the rope maintains its non-linear configuration, thereupon the rope is applied together with a pre-molded thermoplastic round core to a mold and the thermoplastic rubber is bonded to the rope to create the shape of the toy and to surround some, but not all of the rope with the thermoplastic rubber coating.

### TECHNICAL FIELD OF THE INVENTION

The present invention is directed to a canine chew toy and method for its manufacture which provides a rope for chewing and yet partially encapsulates the rope within an abrasion resistant thermoplastic rubber to enhance the toy's durability.

### BACKGROUND OF THE INVENTION

The present invention is directed to a dog toy and method for its manufacture. The stimulus for this invention was the recognition that dogs require chewing to maintain their health and well-being and often times using rope and rope toys for this purpose. However, a healthy dog often times is capable of degrading a rope toy to the point where it no longer can safely be used. Pet owners thus must continuously replace such chew toys much more often than the pet owner would like.

In configuring the appropriate chew toy, certain characteristics were deemed highly desirable in order to achieve a toy which would not only satisfy the pet's need to but also but also enhances its durability. Such a toy needed to provide exposed rope segments for the obvious reason that it is rope which a dog seeks as a preferred chewing surface while at the same time shielding portions of the rope segments for durability. In fabrication, it was recognized that most rope-based chew toys are not linear having curved segments used as handles for tugging against the dog's pull during play as well as generally making the toy more interesting. However, because of the stress created during vigorous play, it was important that the protective sheath surrounding segments of the rope not delaminate resulting in creation of the manufacturing process described and claimed herein.

### SUMMARY OF THE INVENTION

A method of manufacturing a dog toy, said dog toy comprising a rope at least a segment of which is non-linear and having a length, a thermoplastic rubber surrounding some but not all of said rope such that said dog toy is characterized as having exposed rope and rope covered by said thermoplastic rubber along its length such that a dog using said dog toy has access to said rope for chewing but said rope is resistant to degradation due to said thermoplastic rubber, said method comprising bending said rope for a sufficient period of time such that said rope substantially maintains its non-linear configuration, thereupon applying said rope together with a pre-molded thermoplastic round core to a mold and bonding said thermoplastic rubber to said rope to maintain the non-linear configuration of said rope and to surround some, but not all of said rope with said thermoplastic rubber.

### BRIEF DESCRIPTION OF THE DRAWINGS

FIGS. 1-4 depict examples of configurations created in employing the method of the present invention.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

It is been recognized that dogs require chewing to maintain their health and well-being. Rope-based dog toys have been the preferred vehicle for satisfying such needs as dogs gravitate toward the feel and sensory stimulation that it seems only a rope can provide.

There are many types of ropes which can be employed as chew toys and which are useful in practicing the present invention. They include synthetics such as nylons, polypropylenes and polyesters as well as natural fibers such as sisal, all of which can be multi-stranded or braided. Despite the natural durability of most ropes currently available, an aggressively engaged pet can easily degrade to the point of destruction rope-based dog toys in short order.

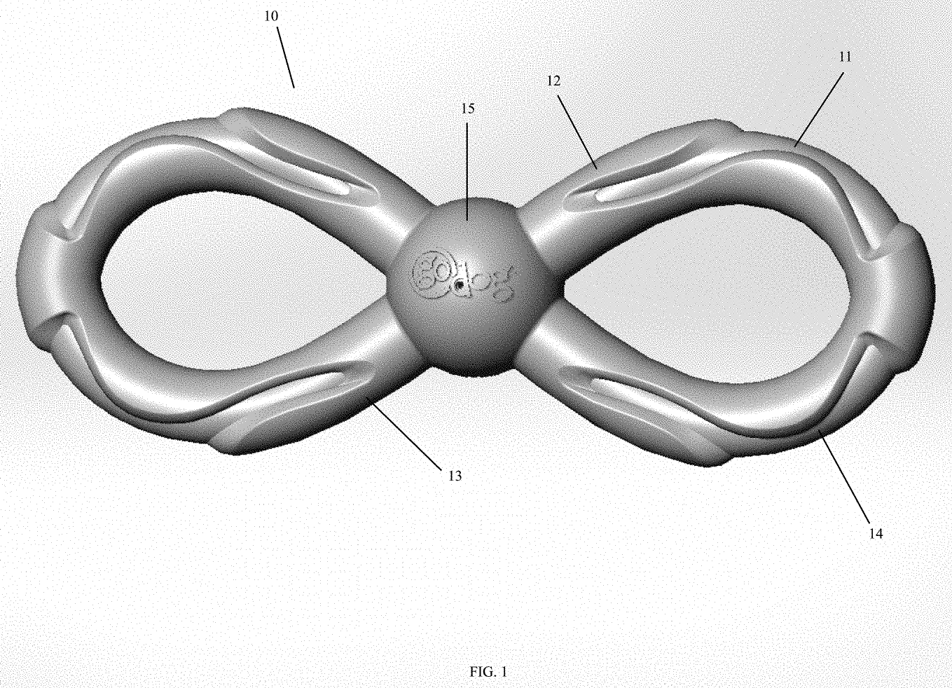

Although it has been found that applying a coating of a thermoplastic rubber to a length of rope enhances the toy's durability, manufacturing such a product while providing the sought after bite resistance was anything but straightforward. As design goals, it was necessary to provide a product in which some of the rope would be exposed and thus available to the dog for chewing. It was also necessary that any process to create the toy must be able to do so with rope and its associated thermoplastic rubber coating that are curved. Examples of suitable toys are shown in FIGS. 1-4.

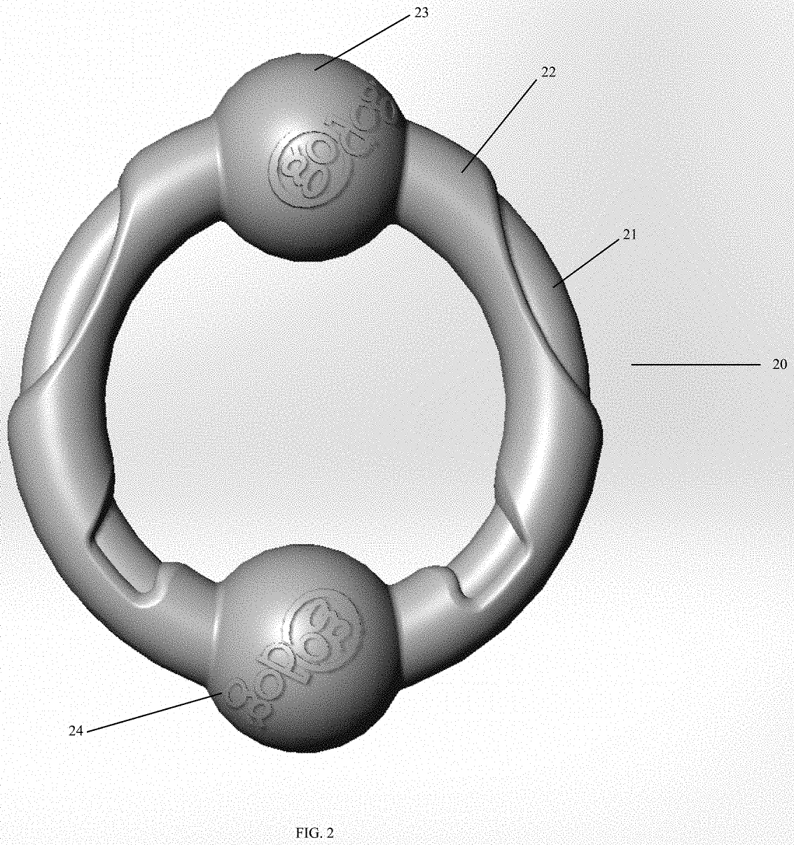

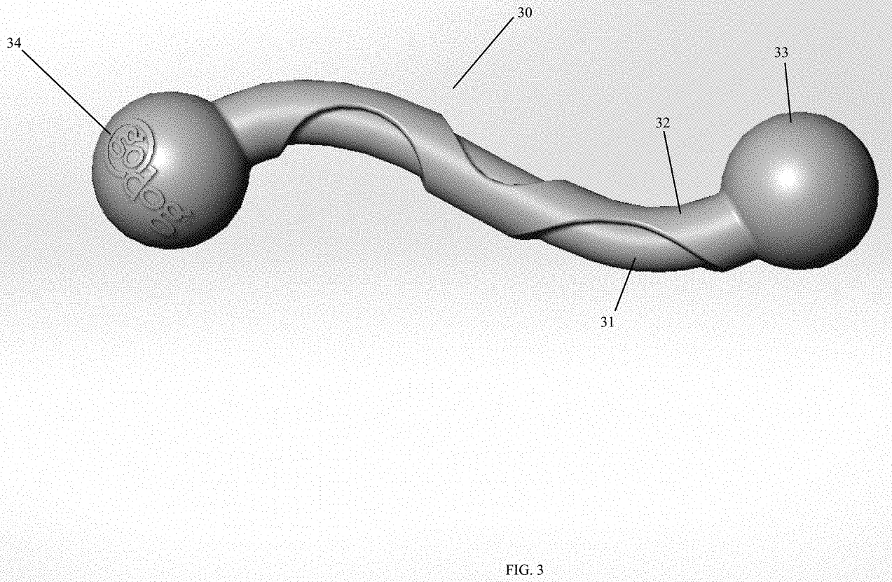

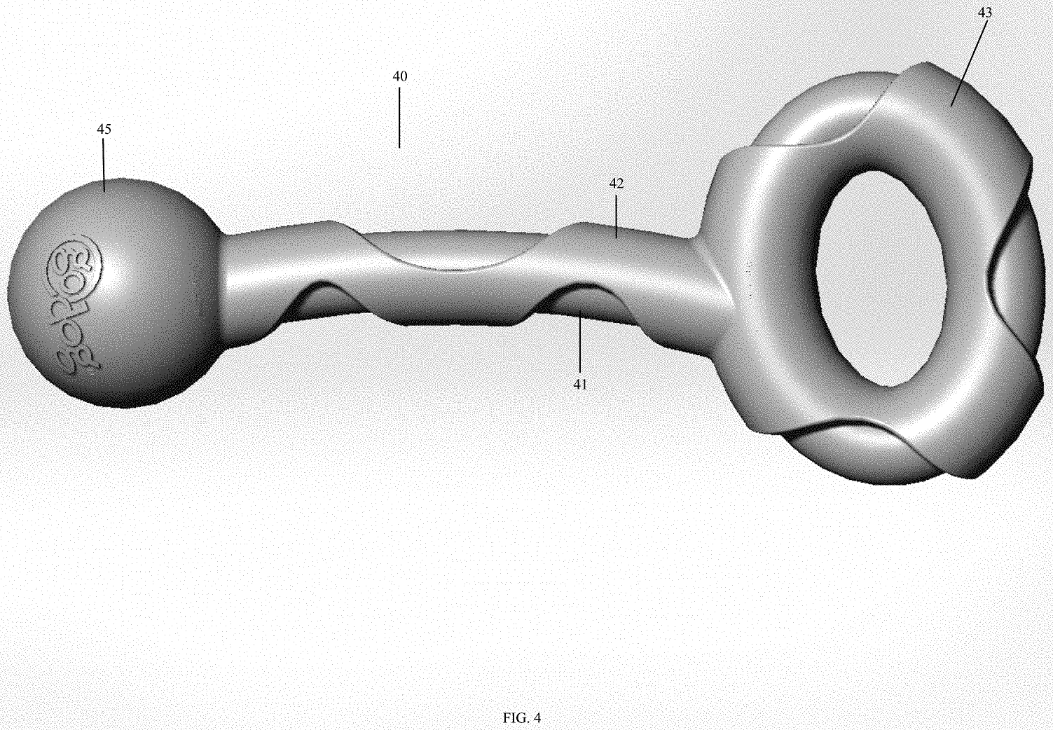

Turning to FIG. 1, dog toy 10 is shown with exposed rope 11 partially covered by thermoplastic rubber 12 (also generally referred to as thermoplastic elastomer). The toy is created in a “figure 8” orientation anticipating that the dog would bite upon one of the loops 13 while the pet owner would grab loop 14 to enable the pet and its owner to play a “tug-of-war” game. An alternative configuration which would provide for a similar play experience is shown in FIG. 2 in which pet toy 20 having exposed rope 21 partially encased by thermoplastic rubber 22 has been formed into a circle. The pet owner could grasp one section of the circle and the dog biting the same toy diametrically opposite to the owners grip would again enable the playing of a “tug-of-war” game. FIG. 3 illustrates dog toy 30 having exposed rope 31 partially covered by thermoplastic rubber 32. Although this toy is more linear than those of the previous embodiments discussed herein, it is still provided with a degree of curvature enhancing the toy's interest to the pet. Finally, FIG. 4 is of toy 40 having exposed rope 41 partially covered by thermoplastic rubber 42. The pet owner could grasp the circular portion 43 allowing the dog to grab the toy at end 44 to again create a “tug-of-war” game. However, it should be recognized that each of these embodiments typify only four of a limitless array of shapes that can be produced according to the present invention which include toys that can be used for chewing without involvement of the pet owner.

As noted previously, it is important that the thermoplastic rubber coating appropriately bond to the rope. The process of molding thermoplastic rubber such as styrene-ethylene/butylene-styrene black copolymers, polyolefin elastomers, polyurethanes, and polyamides is well known. During the fabrication process, outward stress can cause gaps and the air bubbles that can result in delamination over time. It has been found that this can be substantially reduced if not eliminated by pre-bending the rope to reduce/remove outward stress. For example, in turning to FIG. 1, a suitable length of rope would be configured as its intended “figure 8” shape and kept in that shape for a sufficient period of time so that the shape is maintained or “fixed” prior to further fabrication of the dog toy. Most ropes have sufficient memory if the rope once shaped is kept in that shape overnight. Once the shape of the rope is created and thus further bending and shaping is not further required, the rope is laid onto float/riser pins inside a suitable mold. Thereupon, pre-molded thermoplastic rubber round core material is placed into the mold and onto the float/riser pins at which time the mold is closed and the thermoplastic rubber is over-molded to the rope. Upon cooling, the composite is removed from the mold and, because of the pre-bending of the rope to the toy's final shape, outward stress is greatly reduced if not eliminated and a superior bond between the rope and the thermoplastic rubber coating is achieved which reduces gaps and air bubbles that can cause delamination over time.

Optionally, the pet toy of the present invention can also include squeakers which would be housed in bulbous regions 15, 23, 24, 33, 34 and 45, of FIGS. 1-4 respectively. To maintain the integrity of the various squeakers, an optional fabricate method can be employed. Specifically, the rope again would be pre-bent to reduce/remove outward stress and the thermoplastic rubber element would be molded into halves, each of which being of the shape of the pre-bent rope to which it would encase. Once the two halves of the thermoplastic rubber elements are molded, the squeaker would be inserted within the bulbous regions and the two thermoplastic rubber elements heat welded around the squeaker and the rope core.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

1. A method of manufacturing a dog toy, said dog toy comprising a rope at least a segment of which is non-linear and having a length, a thermoplastic rubber coating surrounding some but not all of said rope, said dog toy being characterized as having exposed rope and rope covered by said thermoplastic rubber along its length such that a dog using said dog toy has access to said rope for chewing but said rope is resistant to degradation due to said thermoplastic rubber coating, said method comprising bending said rope for a sufficient period of time such that said rope substantially maintains its non-linear configuration, thereupon applying said rope together with a pre-molded thermoplastic round core to a mold and bonding said thermoplastic rubber to said rope to maintain the non-linear configuration of said rope and to surround some, but not all of said rope with said thermoplastic rubber coating.

2. The method of claim 1 wherein said pre-molded thermoplastic round core compromises a bulbous region to which a squeaker is applied prior to bonding said thermoplastic rubber to said rope.
